(19) United States
(12) Patent Application Publication
(10) Pub. No.: US 2025/0259011 A1
(43) Pub. Date: Aug. 14, 2025

(54) PERFORMANCE MONITORING, MITIGATION, AND RETRAINING OF LARGE LANGUAGE MODELS

(71) Applicant: Cisco Technology, Inc., San Jose, CA (US)

(72) Inventors: Advit DEEPAK, San Jose, CA (US); Raunak SINHA, Los Angeles, CA (US); William HEALY, Riverside, CT (US); Tarun RAHEJA, Philadelphia, PA (US); Jayanth SRINIVASA, San Jose, CA (US); Ramana Rao V. R. KOMPELLA, Foster City, CA (US)

(73) Assignee: Cisco Technology, Inc., San Jose, CA (US)

(21) Appl. No.: 18/440,710

(22) Filed: Feb. 13, 2024

(51) Int. Cl. G06F 40/40; G06F 11/34

(52) U.S. Cl. CPC G06F 40/40; G06F 11/3428

(57) ABSTRACT

In one embodiment, a method herein comprises: extracting topics from queries submitted into a large language model; determining a quality of outputs from the large language model in response to the queries; assessing per-topic performance of the large language model across the topics queried into the large language model based on the quality of the outputs; determining one or more underperforming topics for the large language model based on the per-topic performance of the large language model across the topics; and performing one or more mitigation actions based on the one or more underperforming topics for the large language model. In one implementation, the method comprises: displaying a user interface that indicates the per-topic performance of the large language model across the topics as a heatmap, and delineating the one or more underperforming topics specifically within the heatmap.

### TECHNICAL FIELD

The present disclosure relates generally to computer networks, and, more particularly, to performance monitoring, mitigation, and retraining of large language models.

### BACKGROUND

The recent breakthroughs in large language models (LLMs), such as ChatGPT and GPT-4, represent new opportunities across a wide spectrum of industries. Indeed, the ability of these models to follow instructions now allow for interactions with tools (also called plugins) that are able to perform tasks such as searching the web, executing code, etc. In addition, LLMs are also able to interact with human users in a conversational manner to provide answers to highly technical and complex questions.

Typically, LLMs may perform well in certain areas, but not in others. Often, a knowledge base also has more information on some topics than others, which may be hard for a user or administrator to determine. In addition, LLMs can “drift” over time, losing knowledge in certain areas. Current LLMs also typically lack explainable visualizations to monitor model performance across different areas/topics.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computing system;

FIG. 2 illustrates an example network device/node;

FIG. 3 illustrates an example simplified block diagram of large language model (LLM) performance assessment system;

FIG. 4 illustrates an example of a workflow for addressing low-performing topics;

FIG. 5 illustrates an example of a user interface with a heatmap visualization that highlights areas where an LLM has poor performance or insufficient information for performance verification of the model; and

FIG. 6 illustrates an example procedure for performance monitoring, mitigation, and retraining of LLMs.

### DESCRIPTION OF EXAMPLE EMBODIMENTS

### Overview

According to one or more embodiments of the disclosure, a method herein comprises: extracting topics from queries submitted into a large language model; determining a quality of outputs from the large language model in response to the queries; assessing per-topic performance of the large language model across the topics queried into the large language model based on the quality of the outputs; determining one or more underperforming topics for the large language model based on the per-topic performance of the large language model across the topics; and performing one or more mitigation actions based on the one or more underperforming topics for the large language model.

In one implementation, the method comprises: displaying a user interface that indicates the per-topic performance of the large language model across the topics as a heatmap, and delineating the one or more underperforming topics specifically within the heatmap.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

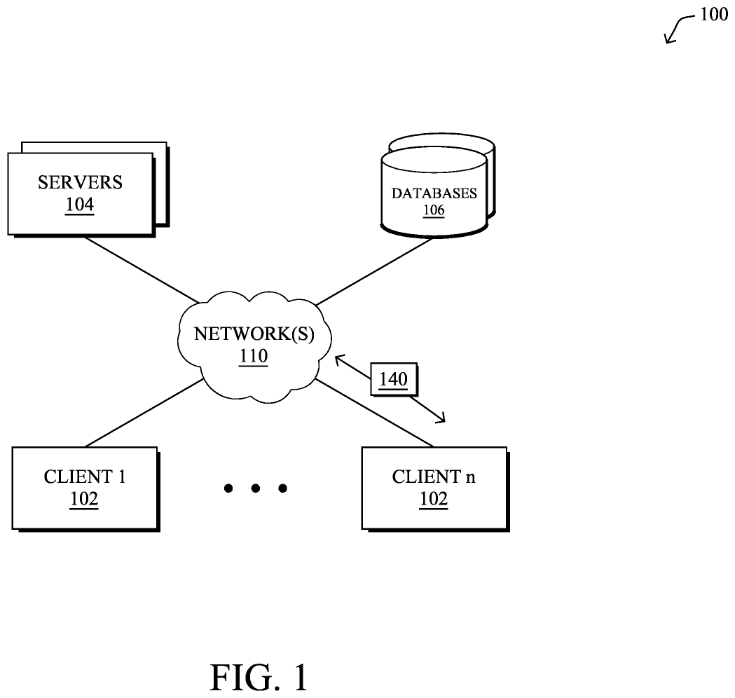

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

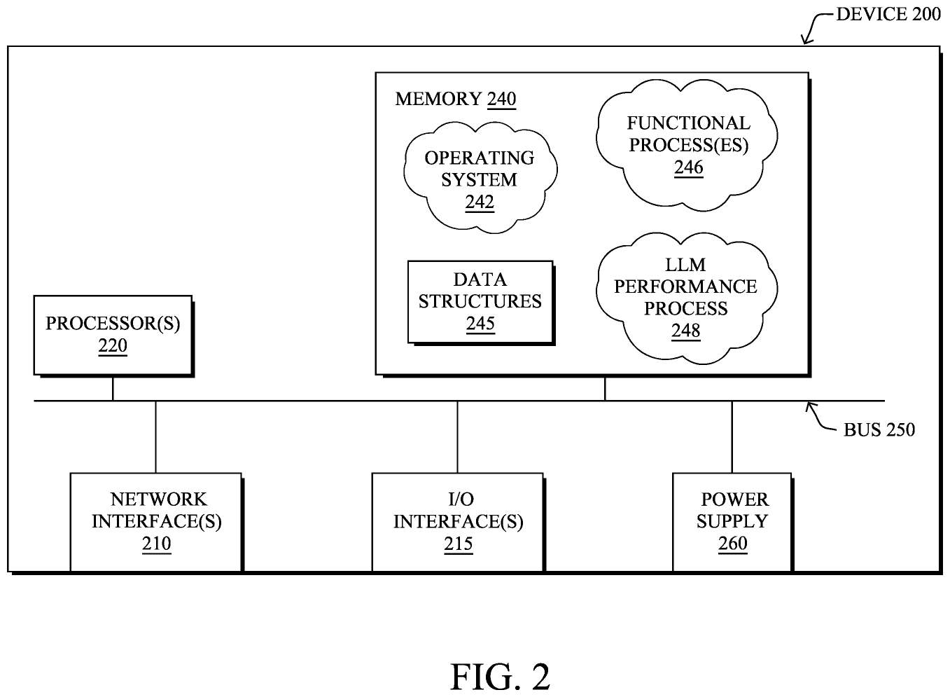

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, a LLM performance process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

In various implementations, as detailed further below, LLM performance process (process 248) may include computer executable instructions that, when executed by processor(s) 220, cause device 200 to perform the techniques described herein. To do so, in some implementations, process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) ANNs (e.g., for non-linear models), replicating reservoir networks (e.g., for non-linear models, typically for time series), random forest classification, or the like.

In further implementations, process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

### —Performance Monitoring, Mitigation, and Retraining of LLMs—

As noted above, large language models (LLMs) represent new opportunities across a wide spectrum of industries, but may perform well in certain areas and not in others. For instance, as also noted above, knowledge bases often have more information on some topics than others, which may be hard for a user or administrator to determine, and LLMs can “drift” over time, losing knowledge in certain areas. Further noted above, current LLMs also typically lack explainable visualizations to monitor model performance across different areas/topics.

LLM “bias”, for example, can occur when an LLM's training data influences its understanding and representation of factual information. In this context, LLM bias can arise from many factors. For instance, data source bias or coverage bias can occur if the language model is trained predominantly on certain types of sources (e.g., news articles, academic papers, or specific genres of books) or when certain areas of knowledge are more heavily represented in the training data than others, such that the LLM may develop a skewed or under-represented understanding of certain topics. For instance, a model trained heavily on scientific literature might not perform as well on pop culture topics (i.e., a comprehensive understanding of one knowledge base topic may provide a limited or superficial understanding of another topic). Temporal bias, on the other hand, may occur when an LLM does not include the most recent information or changes in understanding over time, leading the model to provide outdated or historical perspectives rather than current viewpoints or data.

The techniques herein, therefore, provide for performance monitoring, mitigation, and retraining of large language models. In particular, certain aspects of the techniques herein introduce a self-correcting system to automatically finetune and fix LLMs with external knowledge. Additionally, the techniques herein provide a visualization tool to help visualize the performance of an LLM system across topics, which may help identify LLM performance issues that need assistance. That is, the system herein represents a dynamic approach to handling the inherent limitations of LLMs, ensuring they remain useful, accurate, and up-to-date tools for information retrieval and processing. Also, the visualizations herein enhance the management and utilization of LLMs, providing a clear and actionable roadmap for continuous improvement and user satisfaction.

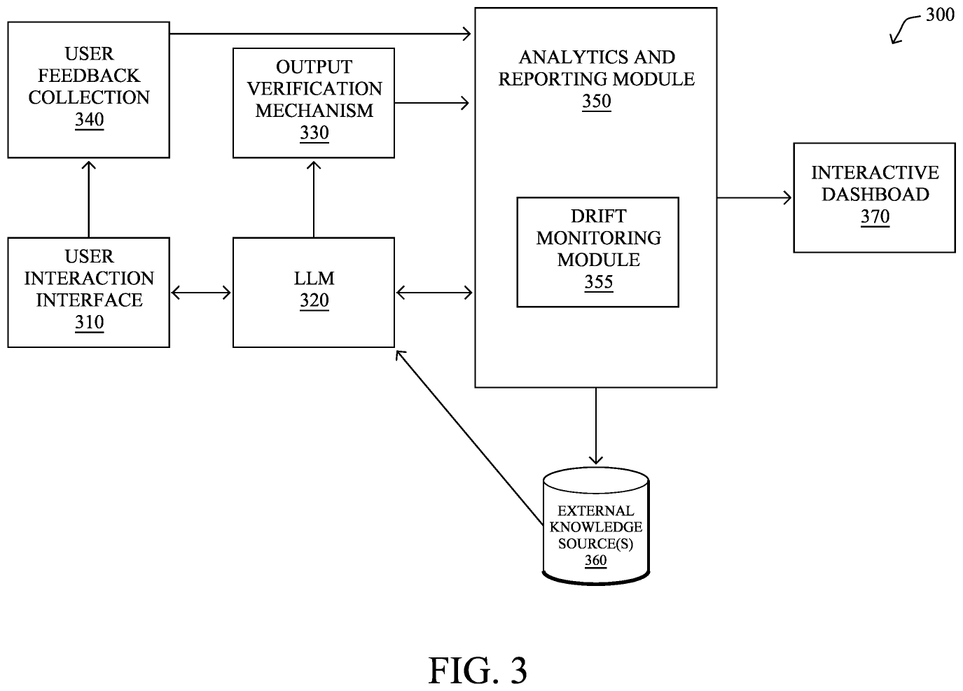

Operationally, the techniques herein first rely on output verification and user feedback to determine queries/topic of low LLM performance. For instance, FIG. 3 illustrates an example simplified block diagram of an LLM performance assessment system (system 300). For instance, a user interaction interface 310 may be where users interact with an LLM 320, inputting queries and receiving responses.

An output verification mechanism 330 may be configured to automatically evaluate the LLM's responses against certain criteria to assess their quality. These criteria could include accuracy, relevance, coherence, and alignment with other guidelines. For example, this could be done using a combination of heuristic rules, smaller specialized models, or comparison against a verified knowledge base.

User feedback collection 340 allows users to provide feedback on the LLM's responses. This could be as simple as a “thumbs up/down” system, or it might allow for more detailed feedback, such as tagging responses as inaccurate, biased, outdated, or irrelevant. Notably, user feedback may be determined either explicitly (e.g., through user ratings) or implicitly (e.g., via engagement metrics).

An analytics and reporting module 350 aggregates and analyzes the feedback and verification data, identifying patterns or trends in the LLM's performance, such as specific topics or types of queries where the model consistently underperforms. The insights from the analytics module may then be fed back into the LLM. According to the techniques herein, this can be done in several ways:
Direct model retraining: Incorporating the identified weaknesses into the LLM's training regime to improve performance.
Model fine-tuning: Adjusting the model's parameters or training it on additional, targeted datasets (e.g., external knowledge source(s) 360) to address specific areas of weakness.
Rule-based overrides: Implementing specific rules or guidelines for the LLM to follow in identified weak areas.

Notably, external knowledge source(s) 360 may be used, in particular, to ensure the LLM has access to current and accurate information, and specifically additional information to use in the model. For instance, as described herein, the system would periodically integrate new external data sources as needed, especially in rapidly evolving knowledge areas or other areas where LLMs are consistently underperforming.

The system herein is also able to analyze areas of uncertainty/incorrectness over time and detect “drift” (the loss of knowledge) in certain areas. For instance, in certain embodiments, a drift monitoring module 355 may analyze LLM outputs over time, such as by using statistical methods and machine learning algorithms to identify patterns of uncertainty or errors in the model's responses (e.g., assessing the confidence level of the LLM in its responses, comparing LLM outputs with trusted external data sources for factual accuracy, or preforming longitudinal analysis to track the consistency of LLM responses over time in various domains, among others). Drift detection may then focus on identifying changes in the LLM's performance over time, such as through:
Change point detection to identify significant shifts in the model's output patterns.
Time-series analysis to track the LLM's performance metrics over time.
Anomaly detection algorithms to flag unusual or unexpected responses that might indicate a drift in the model's understanding or output quality.

Upon detecting areas of drift or consistent inaccuracies, the techniques herein may initiate processes to update the LLM as described above. For instance, LLM updates to counteract drift may be such things as triggering a retraining cycle with updated or additional data, fine-tuning the model on specific domains where drift or inaccuracies are detected, adjusting the model's parameters to correct identified biases or inaccuracies, and so on.

According to one or more aspects of certain implementations of the techniques herein, when a prompt is inputted that is similar to a query that consists of a previously determined low-performing topic, the system herein may also provide extra context, automatically. Alternatively, according to one or more aspects of certain other implementations of the techniques herein, the LLM may be automatically finetuned with extra relevant content (and/or context) on areas of low-performance.

Specifically, one or more aspects of certain implementations of the techniques herein the techniques herein provide a sophisticated, multi-layered approach, which intelligently identifies areas where the LLM typically underperforms and either enriches the response with supplementary information or adapts itself over time for improved performance. For instance, a performance analysis process herein (e.g., analytics and reporting module 350) may continuously evaluate the LLM's performance across different queries to identify topics or types of queries where the LLM's responses are frequently marked as inadequate, inaccurate, or lacking in detail. By utilizing machine learning techniques, the system may recognize patterns in low-performing areas. Then, in one embodiment, once a low-performing topic is identified (e.g., a new query similar to a previous query with an underperformed response), the techniques herein may trigger an additional context retrieval process, which sources supplementary information from a curated, reliable, and up-to-date external database or a specialized subset of the LLM trained specifically for those topics to provide additional context, which is then integrated into the LLM's response (e.g., context for the LLM to process the query, or as additional information supplied within the response/output). Alternatively (or in addition), the system herein may use the identified low-performing areas as signals for fine-tuning, where the LLM may be periodically fine-tuned with targeted datasets that specifically address these weak areas (e.g., involving specialized training on authoritative sources, expert-verified content, or recent data in the relevant field).

Notably, the system 300 herein may also have an interactive dashboard 370 for monitoring by human overseers (e.g., administrators) in order to make the system transparent and manageable. This dashboard would display real-time analytics, drift detection alerts, and user feedback summaries, particularly as described further below. It would allow human supervisors to make informed decisions about when to intervene and how to guide the retraining process.

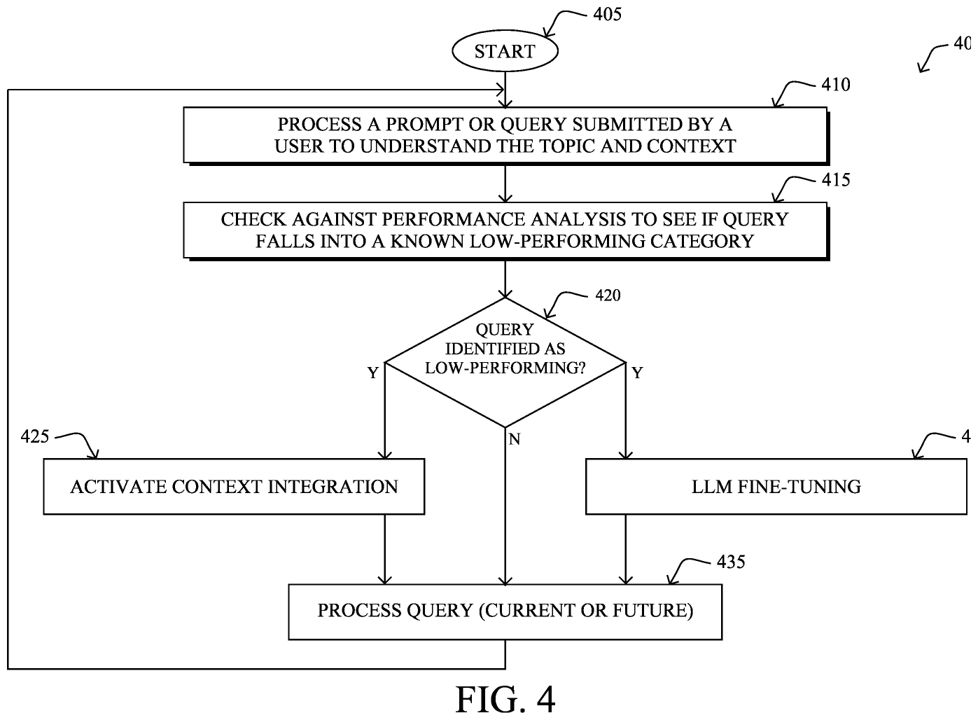

FIG. 4 illustrates an example of a workflow 400 for addressing low-performing topics in accordance with one or more embodiments herein. Starting in step 405, workflow 400 continues to step 410 where the system first processes a prompt or query submitted by a user to understand the topic and context. In step 415 the system checks against the performance analysis above to see if the query falls into a known low-performing category. If the query is identified as low-performing in step 420, two options may then occur next. First, in step 425, context integration activates to either appends extra context to the LLM's response or else the original prompt may be modified to include this context to allow the LLM to produce a better response. Alternatively, in step 430, fine-tuning of the LLM occurs with targeted datasets, as described above, so that future prompts may have the benefit of the additional knowledge base. In step 435, it is shown that either current or future prompts/queries may be processed according to the techniques herein, accordingly.

As such, the system herein would operate in a continuous learning loop, constantly analyzing outputs, user feedback, and external data sources, allowing for dynamic adjustments to keep the model current and accurate. Additional context may assist immediate user prompts, while over time, the LLM becomes more proficient in these areas through targeted training.

According to one or more additional embodiments of the present disclosure, the proposed solution herein involves creating a user interface (UI) with a heatmap visualization that highlights areas where the LLM has poor performance or insufficient information for performance verification of the model. Poor performance, for example, may be based on user feedback or whether Retrieval-Augmented Generation (RAG) is utilized to augment prompts/outputs with additional context to provide better results. This system would be invaluable for administrators and users alike, providing a clear, visual representation of the LLM's strengths and weaknesses, similar to a warning map.

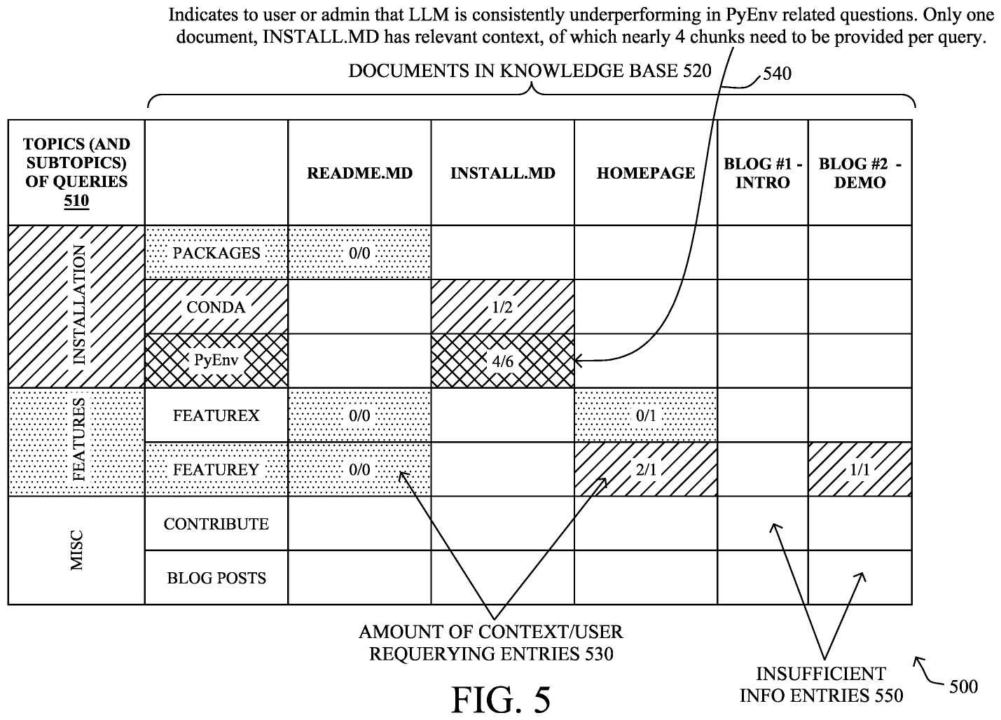

FIG. 5 illustrates an example of a user interface (UI 500) with a heatmap visualization that highlights areas where an LLM has poor performance or insufficient information for performance verification of the model. For instance, interactive dashboard 370 from FIG. 3 above may be configured translate the data from the analytics and reporting module 350 into a visual heatmap. Different colors may be used to indicate varying levels of performance: e.g., red for poor performance areas, yellow for moderate, and green for areas where the LLM performs well. (Other colors or indicators may be used, and those mentioned herein are merely examples for discussion.) Additionally, shades or patterns could further indicate areas with insufficient data for performance assessment.

This administrative dashboard (UI 500) allows administrators to view the heatmap and understand locations and optionally recommendations for model improvement. That is, according to the techniques herein such a heatmap is also able to indicate to the administrator what additional information may be needed in the knowledge base, or which topics an LLM should be assisted in (e.g., RAG, a larger model, etc.). That is, the UI may suggest areas for additional data sourcing, fine-tuning, or where augmented assistance might be beneficial. Moreover, the user/admin may be shown a lower confidence threshold in LLM responses that are in poor/less enterprise-knowledge areas or topics. This enables administrators to prioritize resource allocation for model enhancement based on the heatmap, accordingly.

As shown in FIG. 5, for example the UI may be configured as a dashboard with a table, with rows 510 corresponding to topics (and subtopics) of queries, e.g., “Installation” (sub: “Packages”, “Conda”, “PyEnv”), “Features” (sub: “FeatureX”, “FeatureY”), and “Misc” (sub: “Contribute”, “Blog Posts”). The columns 520 correspond to documents in a knowledge base used for the LLM, such as “README.MD”, “INSTALL.MD”, “Homepage”, “Blog #1—Intro”, and “Blog #2—Demo”. The entries 530 of the table may represent any useful performance metrics and visualizations (e.g., colors/shades/etc.), such as an amount of context (e.g., “chunks”) per user requerying needed. For example, the primary “poor performer” 540 shown indicates to a user or admin that the LLM is consistently underperforming in “PyEnv” related questions. Only one document, “INSTALL.MD” has relevant context, of which nearly four chunks (portions or segments of the text document) need to be provided per query, and six requeries (absolute or on average) were needed for user satisfaction to be achieved. Other entries, such as entries 550, may illustrate areas with insufficient information for performance verification of the model.

The heatmap may be updated in real-time or at regular intervals, reflecting the current state of the LLM's performance across different topics. Administrators can use the heatmap to quickly identify problem areas or knowledge gaps. The UI could also allow administrators to click on heatmap areas for detailed insights and suggestions for improvement. In one embodiment, users/admins may be alerted through the UI when a response falls into any of these low performance categories, possibly with a message indicating lower confidence or suggesting further verification.

By integrating these components, the system would not only address immediate inaccuracies and biases based on user feedback and output verification but also proactively monitor and adjust for long-term shifts in performance (e.g., drifts), ensuring the LLM remains accurate and reliable over time.

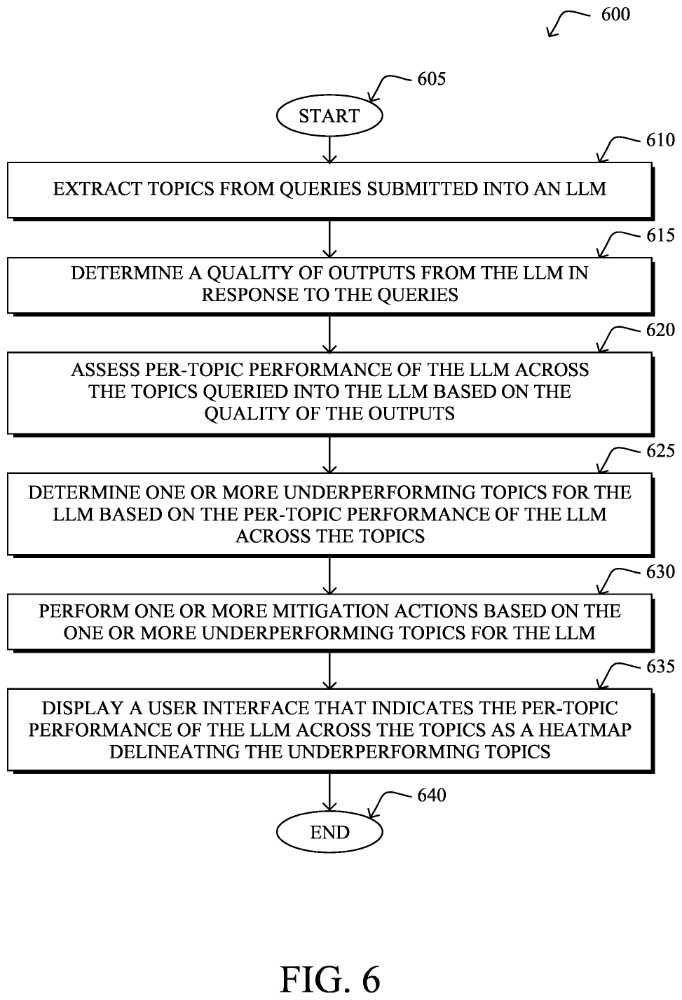

FIG. 6 illustrates an example simplified procedure for performance monitoring, mitigation, and retraining of large language models in accordance with one or more embodiments described herein. For example, a non-generic, specifically configured device (e.g., device 200, an apparatus) may perform procedure 600 by executing stored instructions (e.g., process 248). The procedure 600 may start at step 605, and continues to step 610, where, as described in greater detail above, the techniques herein extract topics from queries submitted into a large language model (LLM).

In step 615, the techniques herein also determine a quality of outputs from the LLM in response to the queries. For instance, as detailed above, quality may be determined based on obtaining one or both of either explicit user feedback or implicit user feedback, and/or obtaining automated verification of the outputs based on an evaluation of the outputs against one more quality assessment criteria. Detecting usage of Retrieval-Augmented Generation (RAG) for one or more particular outputs may also be used as an indicator of quality. As also noted above, the techniques herein may determine performance drift indicative of a loss of knowledge within the LLM based on an increase over time in either uncertainty of the outputs or inconsistencies of the outputs or both.

In step 620, the techniques herein may then assess per-topic performance of the LLM across the topics queried into the LLM based on the quality of the outputs, and in step 625 may further correspondingly determine one or more underperforming topics for the LLM based on the per-topic performance of the LLM across the topics. For example, a certain threshold of poor/good or unacceptable/acceptable quality, a comparative assessment (poor, acceptable, good, etc.), or other measure of performance may be used herein to identify which particular topics are underperforming, accordingly.

In step 630, the techniques herein may then perform one or more mitigation actions based on the one or more underperforming topics for the LLM. For instance, example mitigation actions herein may comprise such things as:
detecting a new query submitted into the LLM that relates to one of the one or more underperforming topics; and providing additional context for the new query;
supplying, into a knowledge base used to train the LLM, additional content related to the one or more underperforming topics; and retraining the LLM with the additional content;
detecting a new query submitted into the LLM that relates to one of the one or more underperforming topics; and tagging an output from the LLM for the new query with a confidence threshold indicative of comparatively low confidence;
and so forth.

Notably, in certain implementations herein, in step 635 the techniques herein may specifically display a user interface that indicates the per-topic performance of the LLM across the topics as a heatmap, and delineate the one or more underperforming topics specifically within the heatmap. As described above, the user interface may be organized to correlate the topics queried into the LLM against documents in a knowledge base from which the LLM has been trained for those topics. Also, the user interface may indicate such things as which of the topics queried into the LLM have insufficient information to verify performance of the LLM, specific information to add to a knowledge base to retrain the LLM for the one or more underperforming topics, and so on. As shown above, the user interface may be configured to not only show underperforming topics, but also a plurality of tiers (e.g., three or more tiers, such as poor, ok, and good) of per-topic performance of the LLM across the topics (e.g., at least one of the three or more tiers corresponding to the one or more underperforming topics). Moreover, as also shown above, the techniques herein may indicate, within the user interface, one or both of a) a number of chunks needed to be provided per query from a knowledge base from which the LLM has been trained for the topics to reach a satisfactory output, or b) a number of requeries needed to reach a satisfactory output.

Procedure 600 may end at step 640, though further monitoring, assessment, and mitigation of the performance of the LLM may proceed accordingly through the steps described above.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor and that is configured to perform the methods described herein.

In still other implementations, a tangible, non-transitory, computer-readable medium storing program instructions that cause a device to execute a process that is configured to perform the methods described herein.

The techniques described herein, therefore, provide for performance monitoring, mitigation, and retraining of large language models. In particular, the techniques herein may be used to determine when an LLM is performing well in certain areas and not in others, whether due to bias, drift, lack of knowledge, and so on, specifically providing useful visualizations to allow for the monitoring of model performance across different areas/topics, accordingly. Additionally, the techniques herein provide a mechanism for diversifying data sources, continually updating the training data to include new (e.g., external) knowledge, to carefully curate data to ensure a proper representation of different fields and subjects within LLM knowledge bases.

The self-correcting system that automatically finetunes and fixes LLMs with external knowledge, for instance, provides extra context for low-performing topics, thus ensuring enhanced accuracy and relevance in responses. The dynamically learning system herein continually adapts and improves, reducing its weak areas over time, and users benefit from more comprehensive and reliable information, especially in complex or evolving topic areas. Additionally, the visualization tool herein provides intuitive heatmaps that are an easily interpretable visual representation of complex data, making it straightforward to identify problem areas. Administrators can thus proactively address areas of poor performance or insufficient data, improving the overall effectiveness of the LLM based on data-driven decision-making in model training and resource allocation.

Illustratively, the techniques described herein may be performed by hardware, software, and/or firmware, (e.g., an “apparatus”) such as in accordance with the LLM performance process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method, comprising:
extracting, by a device, topics from queries submitted into a large language model;
determining, by the device, a quality of outputs from the large language model in response to the queries;
assessing, by the device, per-topic performance of the large language model across the topics queried into the large language model based on the quality of the outputs;
determining, by the device, one or more underperforming topics for the large language model based on the per-topic performance of the large language model across the topics; and
performing, by the device, one or more mitigation actions based on the one or more underperforming topics for the large language model.

2. The method of claim 1, wherein performing the one or more mitigation actions comprises:
displaying a user interface that indicates the per-topic performance of the large language model across the topics as a heatmap; and
delineating the one or more underperforming topics specifically within the heatmap.

3. The method of claim 2, wherein the user interface is organized to correlate the topics queried into the large language model against documents in a knowledge base from which the large language model has been trained for those topics.

4. The method of claim 2, further comprising:
indicating, within the user interface, which of the topics queried into the large language model have insufficient information to verify performance of the large language model.

5. The method of claim 2, further comprising:
indicating, within the user interface, specific information to add to a knowledge base to retrain the large language model for the one or more underperforming topics.

6. The method of claim 2, further comprising:
indicating, within the user interface, three or more tiers of per-topic performance of the large language model across the topics, at least one of the three or more tiers corresponding to the one or more underperforming topics.

7. The method of claim 2, further comprising:
indicating, within the user interface, one or both of a) a number of chunks needed to be provided per query from a knowledge base from which the large language model has been trained for the topics to reach a satisfactory output, or b) a number of requeries needed to reach a satisfactory output.

8. The method of claim 1, wherein performing the one or more mitigation actions comprises:
detecting a new query submitted into the large language model that relates to one of the one or more underperforming topics; and
providing additional context for the new query.

9. The method of claim 1, wherein performing the one or more mitigation actions comprises:
supplying, into a knowledge base used to train the large language model, additional content related to the one or more underperforming topics; and
retraining the large language model with the additional content.

10. The method of claim 1, wherein performing the one or more mitigation actions comprises:
detecting a new query submitted into the large language model that relates to one of the one or more underperforming topics; and
tagging an output from the large language model for the new query with a confidence threshold indicative of comparatively low confidence.

11. The method of claim 1, wherein determining the quality of the outputs from the large language model in response to the queries comprises:
obtaining one of either explicit user feedback, implicit user feedback, or both.

12. The method of claim 1, wherein determining the quality of the outputs from the large language model in response to the queries comprises:
obtaining automated verification of the outputs based on an evaluation of the outputs against one more quality assessment criteria.

13. The method of claim 1, wherein determining the quality of the outputs from the large language model in response to the queries comprises:
detecting usage of Retrieval-Augmented Generation for one or more particular outputs.

14. The method of claim 1, wherein determining the quality of the outputs from the large language model in response to the queries comprises:
determining performance drift indicative of a loss of knowledge within the large language model based on an increase over time in either uncertainty of the outputs or inconsistencies of the outputs or both.

15. An apparatus, comprising:
one or more network interfaces to communicate with a network;
a processor coupled to the one or more network interfaces and configured to execute one or more processes; and
a memory configured to store a process that is executable by the processor, the process comprising:
extracting topics from queries submitted into a large language model;
determining a quality of outputs from the large language model in response to the queries;
assessing per-topic performance of the large language model across the topics queried into the large language model based on the quality of the outputs;
determining one or more underperforming topics for the large language model based on the per-topic performance of the large language model across the topics; and
performing one or more mitigation actions based on the one or more underperforming topics for the large language model.

16. The apparatus of claim 15, wherein performing the one or more mitigation actions comprises:
displaying a user interface that indicates the per-topic performance of the large language model across the topics as a heatmap; and
delineating the one or more underperforming topics specifically within the heatmap.

17. The apparatus of claim 15, wherein performing the one or more mitigation actions comprises:
detecting a new query submitted into the large language model that relates to one of the one or more underperforming topics; and
providing additional context for the new query.

18. The apparatus of claim 15, wherein performing the one or more mitigation actions comprises:
supplying, into a knowledge base used to train the large language model, additional content related to the one or more underperforming topics; and
retraining the large language model with the additional content.

19. The apparatus of claim 15, wherein determining the quality of the outputs from the large language model in response to the queries comprises:
determining performance drift indicative of a loss of knowledge within the large language model based on an increase over time in either uncertainty of the outputs or inconsistencies of the outputs or both.

20. A tangible, non-transitory, computer-readable medium storing program instructions that cause a device to execute a process comprising:
extracting topics from queries submitted into a large language model;
determining a quality of outputs from the large language model in response to the queries;
assessing per-topic performance of the large language model across the topics queried into the large language model based on the quality of the outputs;
determining one or more underperforming topics for the large language model based on the per-topic performance of the large language model across the topics; and
performing one or more mitigation actions based on the one or more underperforming topics for the large language model.
